(19) United States
(12) Patent Application Publication
(10) Pub. No.: US 2006/0252914 A1
(43) Pub. Date: Nov. 9, 2006

(54) Modified rosin ester for water borne heatset weboffset inks

(76) Inventors: Martin Thomas Czebotar, Somerset, NJ (US); Hugo Babij, Waldwick, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/122,145

(22) Filed: May 3, 2005

(51) Int. Cl. C09F 1/00

(52) U.S. Cl. 530/210

(57) ABSTRACT

Disclosed is a modified rosin ester resin suitable for use in a water borne heatset weboffset ink. The rosin ester resin is modified with: (i) maleic anhydride or fumaric acid; and (ii) polyols and has an acid number of about 130 to about 160. The modified rosin ester resin provides good pigment wetting, fast drying, and water solubility.

### FIELD OF THE INVENTION

The present invention relates to modified rosin ester resins for use in heatset weboffset lithographic printing processes.

### OF THE INVENTION

The heat set printing process was first introduced in the 1950's and is now well established in the printing industry for the production of magazines, catalogues and brochures. The process yields high gloss, high quality prints and involves oven drying of the printed product.

In high speed web-offset printing presses, ink is applied to both surfaces of the web substrate simultaneously. To dry the ink before the substrate contacts a solid surface, the printed or coated web is passed through a float or floater type oven under tension and floated between cushions of hot air. Upon leaving the oven, the web must be cooled before further processing, such as sheeting, folding, or rewinding. Thus, the web is passed over one or more chill drums or rolls, i.e., internally cooled drums which reduce the web temperature from about 93° C. to about 32° C. Thus, heat set inks must fulfill exacting criteria to meet the high speed of press runs, the oven drying and required subsequent chilling and still meet the print quality standards. Further discussion of heat set inks and the heat set printing process can be found at The Printing Ink Manual, edited by R. H. Leach and R. J. Pierce, paces 571-576, 5th edition, (Blueprint, 1993).

Generally, lithographic heat-set/offset printing inks predominantly contain petroleum distillates. The fountain solutions typically contain a desensitizer, salts, and glycols. The use of water based inks allows the printer to avoid many of these volatile organic components (“VOCs”) and their byproducts but requires additional equipment such as a humidity control chamber.

The offset lithographic printing process has always presented a unique challenge to ink formulators since the process utilizes a plan ographic printing plate, i.e. the image and non-image areas are in the same plane on the image carrier, and two fluids are concurrently utilized as discussed above. Water based inks have been developed, but remain slow drying and high in tack.

U.S. Pat. No. 5,725,646, which is incorporated herein by reference, describes a way of stabilizing a water based offset ink composition without drying up on a conventional multiple roller ink train using use a re-wetting agent, namely hydroxyethylethylene urea (“HEEU”). Since this re-wetting agent does not dry, it remains in the final film making it susceptible to poor water resistance. High levels of VOCs emanating from the oil-based ink and the aqueous fountain solution were reduced as was the difficulty in controlling the ink/water balance, while preserving the principal advantage of the conventional lithographic printing process, i.e. high surface energy differential between the image and non-image areas of the printing plate. However, the use of conventional re-wetting agents, such as glycols and glycol ethers not only imparts poor water resistance to the final film, but also increases the tack of the formulations, thereby limiting its use on high speed presses.

U.S. Pat. No. 6,444,021, which is incorporated by reference, describes a newspaper ink composition containing a humectant and a modified soybean oil based resin so as to eliminate the need for the humidity control (chamber) associated with water based inks while allowing the use of existing, multiple roller press set-ups. Drying problems remained however as the humectant takes longer to dry once the ink has printed on coated papers.

U.S. Pat. No. 6,444,022 B1 which is incorporated by reference, describes a modified linseed oil reacted with polyglycols. In this manner, the benefits of including HEEU in the composition could be obtained without sacrificing risking water washability. However, dry times remain higher than required for heatset/offset printing.

U.S. Pat. No. 6,709,503 which is incorporated by reference, describes the use of hydroxyethylethylene urea in conjunction with benzoguanamine resin or with certain polyamide resins to allow the formulation of a water based heatset lithographic ink which can be used in existing conventional multiple roller systems without the aid of a humidity chamber.

However, there still exists a need for a water soluble resin that provides for fast drying, low volatile organic content and high viscosity which can be used in preparing heatset/offset printing ink which can be printed at high speed and dry quicker than the prior art referenced above while still maintaining low tack for ink transfer and water resistance after printing.

### SUMMARY OF THE INVENTION

The present invention provides a method of modifying a rosin resin having an acid number from about 130 to about 160 and suited for use water borne heatset weboffset ink, said method comprising:
(a) melting a rosin resin by heating;
(b) reacting said molten rosin resin with:
   (i) maleic anhydride or fumaric acid; and
   (ii) at least one polyol;
(c) collecting water and distillates from reactants; and
(d) stoping reaction once the acid number of about 130 to about 160 of the modifed resin is reached by lowering temperature of reactants to below melting temperature of said modified resin.

Other objects and advantages of the present invention will become apparent from the following description and appended claims.

### DETAILED DESCRIPTION OF THE INVENTION

Traditionally, modified rosin esters using maleic anhydride or fumaric acid and a polyol were produced in the acid value ranges of 200-300, 50-60, and less than 20 for use as oil soluble resins in oil base inks in the Heatset Weboffset area. It has now been surprisingly discovered that a rosin ester resin modified with: (i) maleic anhydride or fumaric acid; and (ii) polyols and having an acid number of about 130 to about 160 provides good pigment wetting, fast drying, low volatile organic content (VOC) less than 1 wt. %, and water solubility. The physical properties of low molecular weight (less than about 1500), acid value of about 130 to about 160, functionality and softening point (Ring & Ball) of 90-170° C., enable the resin to be processed dry or aqueous when dispersing pigment and be used in in heatset weboffset lithographic printing processes.

Specifically, the rosin ester resin is modified by: (a) meltingig with heating; (b) reacting the molten rosin resin with: (i) maleic anhydride or fumaric acid; and (ii) at least one polyol; (c) collecting water and distillates from reactants; and (d) stoping reaction once the acid number of about 130 to about 160 of the modifed resin is reached by lowering temperature of reactants to below melting temperature of the modified resin.

Preferably, the polyol is selected from the group consisting of: ethylene glycol, trimethylol propane, pentaerythritol, di-trimethylol propane, and di-pentaerythritol. Most preferably, the polyol is pentaerythritol or ethylene glycol.

Preferably, the desired acid number of the modified resin is from about 137 to about 150, most from about 140 to about 150.

Again preferably, during the modification process of the rosin resin, the maleic anhydride or fumaric acid are reacted first with the molten resin for a period of time followed by addition of the polyol.

Preferably, the modified rosin resin has a low average molecular weight, most preferably less than about 1,500.

The modified rosin resin of the invention can be used in preparing an aqueous varnish (containing water) suitable for use in a water borne heatset weboffset ink. Preferably, the amount of water present in the varnish is from about 30 to about 70 wt. %. Also preferably, the amount of modified resin present in the varnish is from about 30 to about 70 wt. %.

The modified rosin resin of the invention can be also be used in preparing a water borne heatset weboffset ink having less than 1 wt. % VOC and which comprises: water; the modified rosin resin of claim 9; and pigment.

Preferably, the amount of water present in the ink is from about 5 to about 35 wt. %. Also preferably, the amount of modified resin present in the ink is from about 10 to about 60 wt. %.

Water

The water based printing inks of the present invention contain water to act as a rheology and/or a surface energy modifier of the ink composition and to enhance the water washability of the ink. The water may be an added component or be contributed by one of the other components of the composition such as residual water from a pigment flush or press cake.

Pigment

Preferably, the amount of pigment present in the ink is from about 5 to about 20 wt. %. The pigment may be any of those which are suitable for formulating offset lithographic printing inks such as dry powder, flush, presscake or pigment dispersions. Such pigments include CI Pigment Yellows 1, 3, 4, 5, 12, 13, 14, 17, 55, 65, 73, 83, 97 and 98; CI Pigment Oranges 13, 16 and 46; CI Pigment Reds 2, 3, 4, 10, 12, 48, 48:1, 48:2, 53, 57:2, 81, 104, 146, 170 and 176; CI Pigment Greens 2, 7 and 36; CI Pigment Blues 1, 15:1, 15:2, 15:3, 15:6, 16, 29, 56 and 61; CI Pigment Violets 3, 23 and 37; CI Pigment Blacks 6 and 7; and CI Pigment Whites 6, 7, 18 and 26.

Printing plates for use with the printing ink of the present invention can have image areas hydrophilic in nature with non-image areas hydrophobic in nature. An example of a suitable printing plate is the “waterless” Toray type. However, the image area of the plate need not contain a photo polymer. The image area of the plate may comprise, e.g. a grained aluminum surface which has no coating thereon, but is hydrophilic in nature. While the non-image area of the plate must be hydrophobic in nature, it may merely be covered with any type of hydrophobic material, provided that such hydrophobic material adheres to the non-image area of the plate during the printing process.

### EXAMPLE 1

### Preparation of Modified Rosin Ester Resin 1

Mexican gum rosin (76.19 parts) was charges to a four neck reaction flask equipped with a nitrogen gas inlet adapter, thermometer, mechanical agitation, heating mantle, distillation trap, and condenser. Heat was applied to melt the gum rosin under a nitrogen blanket. Once the rosin has melted, agitation was turned on at a rate to cause the molten rosin to flow uniformly. At 160° C., maleic anhydride (15.24 parts) was added to the reactor in an exothermic reaction. The batch temperature was maintained at 200° C. for two hours. thereafter, the acid value was checked for process control. Then, pentaerythritol (8.57 parts) was added to the reactor and slowly heated to 260° C. During heat up water and distillates are collected. AT 230° C., acid value was checked every hour. The batch temperature was maintained at 260° C. until acid value of 137-143 was reached. The molten resin was then poured into aluminum pans for cooling and collection. The hard resin was used to prepare an aqueous varnish as indicated in Example 2.

### EXAMPLE 2

### Preparation of Aqueous Varnish 1

Crushed modified rosin ester resin 1 (34.64 parts as prepared in Example 1), deionized water (59.81 parts) and monoethanol amine (5.55 parts) were added to a four neck reaction flask equipped with a nitrogen gas inlet adapter, thermometer, mechanical agitation, heating mantle, and condenser. The mixture was heated to 95° C. At 95° C., the batch was held until the resin was dissolved. Then the varnish is discharged to jars.

### EXAMPLE 3

### Preparation of Modified Rosin Ester Resin 2

Mexican gum rosin (82.8 parts) was charged to a four neck reaction flask equipped with a nitrogen gas inlet adapter, thermometer, mechanical agitation, heating mantle, distillation trap, and condenser. Heat was applied to melt the gum rosin under a nitrogen blanket. After the rosin was melted, agitation was turned on at a rate to cause the molten rosin to flow uniformly. At 160° C., maleic anhydride (11.18 parts) was added to the reactor in an exothermic reaction. Thereafter, the batch temperature was maintained at 200° C. for two hours. then the acid value was checked for process control. Thereafter, ethylene glycol (6.02 parts) was added to the reactor and slowly heated to 230° C. During heat up water and distillates are collected. The batch temperature was maintained at 230° C. until acid value of 140-145 was reached. The molten resin was poured into aluminum pans for cooling and collection. The hard resin was used for encapsulation or conversion to an aqueous varnish as described in Example 4.

### EXAMPLE 4

### Preparation of Aqueous Varnish 2

Crushed modified rosin ester resin 2 (51.88 parts), deionized water (40 parts)and monoethanol amine (8.12 parts) were added to a four neck reaction flask equipped with a nitrogen gas inlet adapter, thermometer, mechanical agitation, heating mantle and condenser. The mixture was heated to 95° C. and held until the resin has dissolved. Then the varnish was discharged to jars.

The invention has been described in terms of preferred embodiments thereof, but is more broadly applicable as will be understood by those skilled in the art. The scope of the invention is only limited by the following claims.

What is claimed is:

1. A method of modifying a rosin resin having an acid number from about 130 to about 160 and suited for use water borne heatset weboffset ink, said method comprising:
(a) melting a rosin rein by heating;
(b) reacting said molten rosin resin with:
(i) maleic anhydride or fumaric acid; and
(ii) at least one polyol;
(c) collecting water and distillates from reactants; and
(d) stoping reaction once the acid number of about 130 to about 160 of the modifed resin is reached by lowering temperature of reactants to below melting temperature of said modified resin.

2. The method of claim 1, wherein said polyol is selected from the group consisting of: ethylene glycol, trimethylol propane, pentaerythritol, di-trimethylol propane, and di-pentaerythritol.

3. The method of claim 2, wherein said polyol is pentaerythritol.

4. The method of claim 2, wherein said polyol is ethylene glycol.

5. The method of claim 1, wherein said desired acid number of the modified resin is from about 137 to about 150.

6. The method of claim 5, wherein said desired acid number of the modified resin is from about 140 to about 150.

7. The method of claim 1, wherein said maleic anhydride or fumaric acid are reacted first with the molten resin for a period of time followed by addition of said polyol.

8. The method of claim 1, wherein said modified rosin resin has an average moleculer weight of less than about 1,500.

9. A modified rosin resin prepared acccording to claim 1.

10. An aqueous varnish suitable for use in a water borne heatset weboffset ink comprising:
(a) water; and
(b) the modified rosin resin of claim 9.

11. The varnish of claim 10, wherein the amount of water present is from about 30 to about 70 wt. %.

12. The varnish of claim 10, wherein the amount of modified resin present is from about 30 to about 70 wt. %.

13. A water borne heatset weboffset ink having less than 1 wt. % VOC comprising:
(a) water;
(b) the modified rosin resin of claim 9; and
(c) pigment.

14. The ink of claim 13, wherein the amount of water present is from about 5 to about 35 wt. %.

15. The ink of claim 13, wherein the amount of modified resin present is from about 10 to about 60 wt. %.

16. The ink of claim 13, wherein the amount of pigment present is from about 5 to about 20 wt. %.

17. The ink of claim 13, wherein the pigment is selected from the group consisting of CI Pigment Yellows 1, 3, 4, 5, 12, 13, 14, 17, 55, 65, 73, 83, 97 and 98; CI Pigment Oranges 13, 16 and 46; CI Pigment Reds 2, 3, 4, 10, 12, 48, 48:1, 48:2, 53, 57:2, 81, 104, 146, 170 and 176; CI Pigment Greens 2, 7 and 36; CI Pigment Blues 1, 15:1, 15:2, 15:3, 15:6, 16, 29, 56 and 61; CI Pigment Violets 3, 23 and 37; CI Pigment Blacks 6 and 7; and CI Pigment Whites 6, 7, 18 and 26.
